(19) United States
(12) Patent Application Publication
(10) Pub. No.: US 2014/0143421 A1
(43) Pub. Date: May 22, 2014

(54) METHOD FOR CONTROLLING WEB APPLICATION THROUGH A SMART TERMINAL AND A SMART TERMINAL FOR CONTROLLING WEB APPLICATION

(71) Applicant: Tencent Technology (Shenzhen) Company Limited, Shenzhen (CN)

(72) Inventors: Yunlei FU, Shenzhen (CN); Shujian YUAN, Shenzhen (CN); Yafeng ZHANG, Shenzhen (CN)

(73) Assignee: Tencent Technology (Shenzhen) Company Limited, Shenzhen (CN)

(21) Appl. No.: 14/142,367

(22) Filed: Dec. 27, 2013

Related U.S. Application Data
(63) Continuation of application No. PCT/CN2013/085315, filed on Oct. 16, 2013.

(30) Foreign Application Priority Data
Nov. 22, 2012 (CN) 201210478577.4

(51) Int. Cl. H04L 12/24

(52) U.S. Cl. CPC H04L 41/50
USPC 709/225

(57) ABSTRACT

The present disclosure discloses a method for controlling web application through a smart terminal and a smart terminal for controlling web application. In the method, the smart terminal notifies the server device to enter the audio control mode after the authentication and registration of the server device. The smart terminal receives an audio input signal and detects a signal level of the audio input signal. The smart terminal notifies the server device to trigger control of corresponding web application, based on the detected signal level. The present disclosure enables a smart terminal to control computer programs. The smart terminal can control web applications by a mobile phone audio transducer. The method facilitates user convenience in the control of web application on a computer by an audio transducer of a smart phone, and improves the flexibility of web application control.

### CROSS-REFERENCE TO RELATED APPLICATIONS

This application is a continuation application of PCT Patent Application No. PCT/CN2013/085315, entitled “A METHOD FOR CONTROLLING WEB APPLICATION THROUGH A SMART TERMINAL AND A SMART TERMINAL FOR CONTROLLING WEB APPLICATION” filed on Oct. 16, 2013, which claims priority to a Chinese Patent Application No. 201210478577.4, filed on Nov. 22, 2012, both of which are incorporated by reference in their entireties.

### FIELD OF THE TECHNOLOGY

The present disclosure relates generally to the field of computer and mobile communication technologies and, more particularly, to a method for controlling web application through a smart terminal and a smart terminal for controlling web application.

### BACKGROUND

Along with the development of network technologies, it is now possible to load various web applications such as games onto personal computers; and for operational convenience, users long to control the operation of web applications on personal computers through mobile phones.

In the existing technologies, Android mobile phones can communicate with personal computers through wireless network connections such as Bluetooth. However, Android mobile phones at present can only control the operation of web applications based on this method of wireless communication by controlling keyboards at personal computers, and the operation is inconvenient and inflexible.

### SUMMARY OF THE DISCLOSURE

The present disclosure aims at providing a method for controlling web application through a smart terminal and a smart terminal for controlling web application so as to achieve sound-based control over web application of personal computer and thereby improving the flexibility of web application.

To achieve the above objectives, the present disclosure provides a method for controlling a web application on a server device through a smart terminal. In the method comprising, the smart terminal notifies the server device to enter an audio control mode, after the smart terminal authenticates and registers with the server device. The smart terminal receives an audio input signal and detecting a signal level of the audio input signal. The smart terminal notifies the server device to trigger control of corresponding web application, based on the detected signal level.

The present disclosure further provides a smart terminal for controlling web application. The smart terminal includes a processor and a non-transitory storage medium accessible to the processor. The non-transitory storage medium is configured to store: an initiation module, a detection module, and a control module. The initiation module is configured to notify the server device to enter an audio control mode, after the smart terminal authenticates and registers with the server device. The detection module is configured to receive an audio input signal and detect a signal level of the audio input signal. The control module is configured to notify the server device to trigger control of corresponding web application, based on the detected signal level.

### BRIEF DESCRIPTION OF THE DRAWINGS

FIG. 1 is a process flow diagram of a first embodiment of a method for controlling web application through a smart terminal of the present disclosure.

FIG. 2 is a schematic diagram of the wireless Bluetooth connection between a mobile phone and a personal computer.

FIG. 3 is a process flow diagram of a second embodiment of a method for controlling web application through a smart terminal of the present disclosure.

FIG. 4 is a structural block diagram of an example embodiment of a smart terminal for controlling web application of the present disclosure.

### DETAILED DESCRIPTION OF THE EMBODIMENTS

For a better understanding of the technical scheme thereof, the present disclosure is described in further detail in connection with the accompanying drawings as follows.

The present disclosure provides a method for controlling web application through a smart terminal and a smart terminal for controlling web application, the method comprising: the smart terminal notifying the server device to enter the audio control mode, after the authentication and registration of the server device; receiving an audio input signal and detecting a signal level of the audio input signal; and notifying the server device to trigger control of corresponding web application, based on the detected signal level. The present disclosure resolves problems associated with computer process control of smart terminals, achieves control of web application by means of a mobile phone audio transducer, facilitates user convenience in the control of web application on a PC terminal by means of an audio transducer of an Android mobile phone, and improves the flexibility of web application.

In the present disclosure: the smart terminal notifies the server device to enter the audio control mode, after the authentication and registration of the server device; receives an audio input signal and detects a signal level of the audio input signal; and notifies the server device to trigger control of corresponding web application, based on the detected signal level; so as to resolve problems associated with computer process control of smart terminals such as an Android mobile phone, to achieve control of web application by means of a mobile phone audio transducer, to facilitate user convenience in the control of web application on a server device by means of an audio transducer of an Android mobile phone, and to improve the flexibility of web application.

The present disclosure takes into consideration that: as existing smart phones (such as Android mobile phones) have audio transducer (microphone) function, this function of a smart phone can be used along with a personal computer to interactively control the web application of that personal computer.

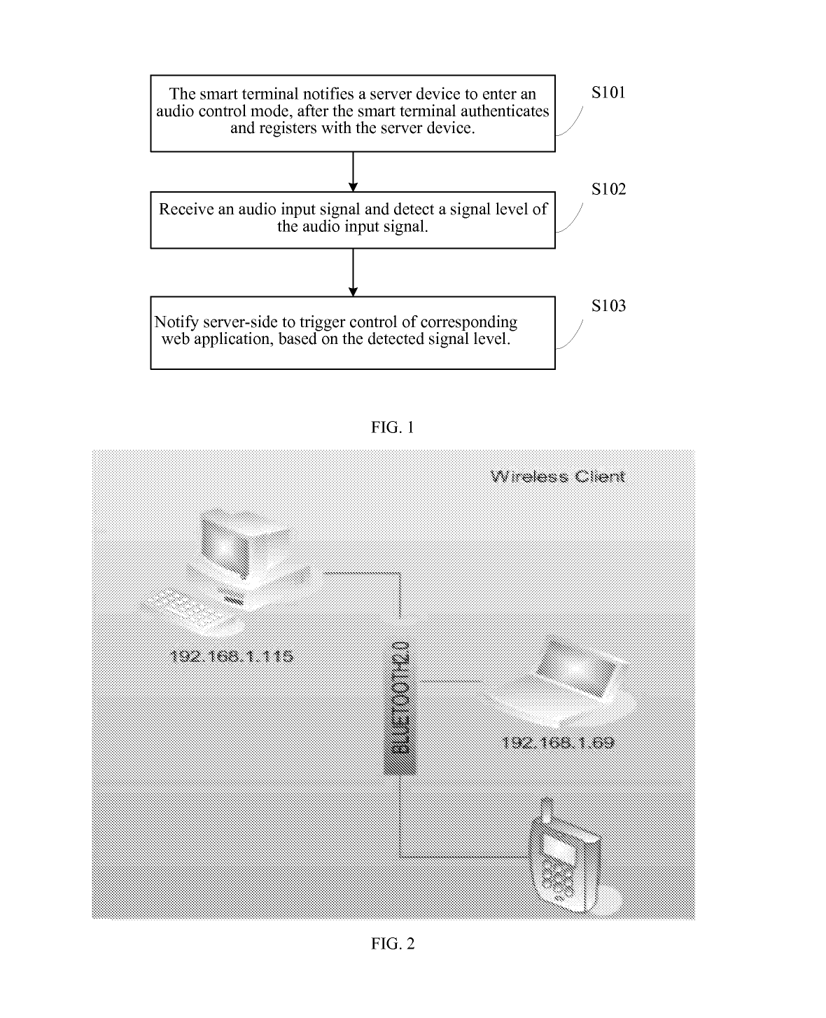

For example, as shown in FIG. 1, a first embodiment of the present disclosure provides a method for controlling web application through a smart terminal, the method comprising:

Step S101—the smart terminal notifies the server device to enter the audio control mode, after the smart terminal authenticates and registers with the server device.

In this embodiment, an Android smart phone may be the smart terminal and a computer may be the server device. It should be noted that the server device may be any computing device having a processor and a memory storage accessible to the processor. The mobile phone and the personal computer may be wirelessly connected through various means including but not limited to Bluetooth or Wi-Fi as shown in FIG. 2, which is a schematic diagram of the wireless Bluetooth connection between a mobile phone and a personal computer.

In this embodiment, an application runs in the personal computer is controlled by the smart phone. For example, a web application may be controlled the smart phone based an audio signal received by an audio sensor of the smart phone. When the user audio signal changes, the web application can be notified and respond to the changes accordingly.

First, the mobile phone needs to be authenticated and registered at the server device. After the authentication and registration, the mobile phone notifies the server device such as a personal computer to enter the audio control mode. Once the mobile phone and the personal computer are successfully linked, web applications that run in the personal computer (such as games) can be controlled by the audio dB level.

Step S102—receive an audio input signal and detect a signal level of the audio input signal. The signal level may be a dB level of the audio input signal.

Once the mobile phone enters the audio control mode, it receives an audio input signal through an audio transducer (in other embodiments, the mobile phone may have a built-in audio module capable of audio reception) under an external environment and it detects the dB level of the received audio input signal in order to control web application of the personal computer according to the detected dB level of the received audio input signal, thereby causing web application to make a corresponding operation response.

Step S103—notify server device to trigger control of corresponding web application, based on the detected signal level.

The mobile phone determines whether to notify the personal computer to trigger control of web application based on the dB level of the audio input signal detected. When the dB level of the audio input signal is higher than the preset threshold level corresponding to a web application, the mobile phone notifies the personal computer to trigger operational control of the web application. At the same time, the mobile phone notifies the personal computer to control the web application to make a corresponding response, based on the change in the dB level of the detected audio input signal.

Taking an application scenario of beating a table to trigger a game as an example:

Once the Android mobile phone enters the audio control mode, the mobile phone is horizontally placed on a table. Through the sound generated by beating the table, control of drumming action in a drumming game is achieved, wherein the game at the personal computer is notified to trigger actions when the sound generated by the beating exceeds a preset threshold and the game will not be triggered by speech threshold.

By adopting the aforementioned scheme, this embodiment resolves problems associated with computer process control of smart terminals such as an Android mobile phone, achieves control of web application by means of a mobile phone audio transducer, facilitates user convenience in the control of web application on a PC terminal by means of an audio transducer of an Android mobile phone, and improves the flexibility of web application.

As shown in FIG. 3, a second embodiment of the present disclosure provides a method for controlling web application through a smart terminal. This method is based on the method of the first embodiment, and comprises the following step before the aforementioned step S101:

Step S100—the smart terminal searches for the server device through a wireless network and, after finding the server device, it initiates authentication and registration process.

The second embodiment is different from the first embodiment in that the second embodiment further comprises the process of authentication and registration of the smart terminal at the server device.

For example, take an Android mobile phone and a personal computer as an example. First, the mobile phone needs to search for a service terminal at a personal computer through Bluetooth or Wi-Fi service. If a service terminal is found, it is initiated and the process of authentication and registration is initiated. After the authentication and registration, the mobile phone notifies the personal computer to enter the audio control mode. Once the mobile phone and the personal computer are successfully linked, web application can be controlled by the audio dB level. Other processes of the second embodiment are identical to those of the first embodiment.

By adopting the aforementioned scheme, this embodiment achieves authentication and registration at the server device and resolves problems associated with computer process control of smart terminals such as an Android mobile phone, achieves control of web application by means of a mobile phone audio transducer, facilitates user convenience in the control of web application on a PC terminal by means of an audio transducer of an Android mobile phone, and improves the flexibility of web application.

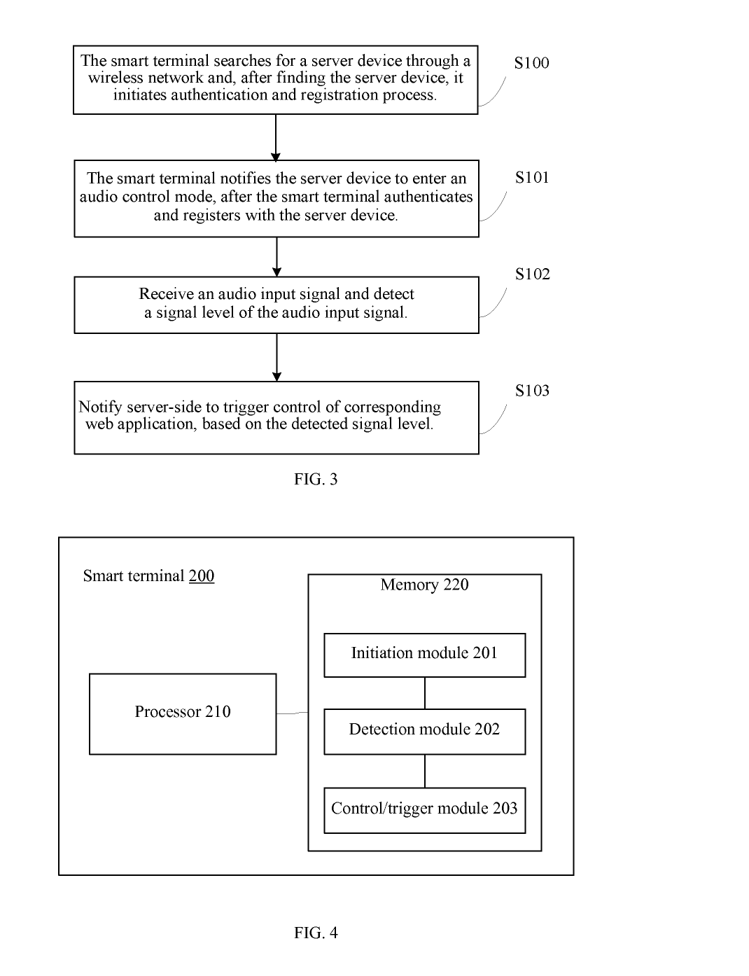

As shown in FIG. 4, an embodiment of the present disclosure provides a smart terminal for controlling web application. The smart terminal includes a processor 210 and a memory 220. The memory may be a non-transitory storage medium that is configured to store: an initiation module 201, a detection module 202 and a control module 203.

The initiation module 201 is used for the smart terminal to notify the server device to enter the audio control mode, after the authentication and registration of the server device.

The detection module 202 is configured to receive an audio input signal and detecting the dB level of the audio input signal.

The control module 203 is configured to notify the server device to trigger control of corresponding web application, based on the detected signal level.

In this embodiment, an Android smart phone is the smart terminal and a personal computer is the server device. The mobile phone and the personal computer may be wirelessly connected through various means including but not limited to Bluetooth or Wi-Fi as shown in FIG. 2, which is a schematic diagram of the wireless Bluetooth connection between a mobile phone and a personal computer.

In this embodiment, web application of the personal computer is controlled by the audio dB level received by the audio transducer of the Android smart phone, and when the user audio dB level changes, web application can be notified to a corresponding response.

First, the mobile phone needs to be authenticated and registered at the personal computer. After the authentication and registration, the initiation module 201 notifies the personal computer to enter the audio control mode. Once the mobile phone and the personal computer are successfully linked, web application of the personal computer (such as games) can be controlled by the audio dB level.

Once the mobile phone enters the audio control mode, the detection module 202 receives an audio input signal through an audio transducer (in other embodiments, the mobile phone may have a built-in audio module capable of audio reception) under an external environment and it detects the dB level of the received audio input signal in order to control web application of the personal computer according to the detected dB level of the received audio input signal, thereby causing web application to make a corresponding operation response.

Thereafter, the control module 203 determines whether to notify the personal computer to trigger control of web application based on the dB level of the audio input signal detected by the detection module 202. When the dB level of the audio input signal is higher than the preset threshold level corresponding to a web application, the mobile phone notifies the personal computer to trigger operational control of the web application. At the same time, the mobile phone notifies the personal computer to control the web application to make a corresponding response, based on the change in the dB level of the detected audio input signal.

Taking an application scenario of beating a table to trigger a game as an example:

Once the Android mobile phone enters the audio control mode, the mobile phone is horizontally placed on a table. Through the sound generated by beating the table, control of drumming action in a drumming game is achieved, wherein the game at the personal computer is notified to trigger actions when the sound generated by the beating exceeds a preset threshold and the game will not be triggered by speech threshold.

By adopting the aforementioned scheme, this embodiment resolves problems associated with computer process control of smart terminals such as an Android mobile phone, achieves control of web application by means of a mobile phone audio transducer, facilitates user convenience in the control of web application on a PC terminal by means of an audio transducer of an Android mobile phone, and improves the flexibility of web application.

Further, the aforementioned initiation module 201 searches for the server device through a wireless network and, after finding the server device, it initiates authentication and registration process.

For example, take an Android mobile phone and a personal computer as an example. First, the mobile phone needs to search for a service terminal at a personal computer through Bluetooth or Wi-Fi service. If a service terminal is found, it is initiated and the process of authentication and registration is initiated. After the authentication and registration, the mobile phone notifies the personal computer to enter the audio control mode. Once the mobile phone and the personal computer are successfully linked, web application can be controlled by the audio dB level. Other processes of the second embodiment are identical to those of the first embodiment.

The present disclosure provides a method for controlling web application through a smart terminal and a smart terminal for controlling web application, wherein the smart terminal first undergoes authentication and registration at the server device; after the authentication and registration, the server device is notified to enter the audio control mode; an audio input signal is received and the dB level of the audio input signal is detected; and based on the detected signal level, the server device is notified to trigger control of corresponding web application. The present disclosure resolves problems associated with computer process control of smart terminals such as an Android mobile phone, achieves control of web application by means of a mobile phone audio transducer, facilitates user convenience in the control of web application on a PC terminal by means of an audio transducer of an Android mobile phone, and improves the flexibility of web application.

It must be noted that the smart terminal of the present disclosure is not limited to smart phones, the server device is not limited to personal computer, and the disclosed method is also suitable for operating systems other than Android systems. The server device may be a computer, a tablet, a smart phone, or any computing device. The disclosed methods in the above embodiments may be combined with each other.

Disclosed above are only embodiments of the present disclosure and these embodiments are not intended to be limiting the scope of the present disclosure, hence any equivalent variations made based on the prospectus and accompanying drawings of the present disclosure, or any direct or indirect use based thereon in other related fields shall fall within the scope of the present disclosure.

What is claimed is:

1. A method for controlling a web application on a server device, comprising:
notifying, by a smart terminal having a processor, the server device to enter an audio control mode, after the smart terminal authenticates and registers with the server device;
receiving, by the smart terminal, an audio input signal and detecting a signal level of the audio input signal; and
notifying, by the smart terminal, the server device to trigger control of corresponding web application, based on the detected signal level.

2. The method of claim 1, wherein notifying server device to trigger control of corresponding web application, based on the detected signal level comprises:
notifying the server device to trigger control of the web application when the detected signal level is higher than a preset dB threshold corresponding to the web application.

3. The method of claim 2, wherein notifying the server device to trigger control of corresponding web application, based on the detected signal level further comprises:
notifying the server device to control the web application to a corresponding response based on a dB level change of the detected signal.

4. The method of claim 1, wherein the smart terminal notifies the server device to enter the audio control mode after the authentication and registration at server device, the method further comprises:
the smart terminal searches for the server device through a wireless network and, after finding the server device, initiates authentication and registration process.

5. The method of claim 5, wherein the wireless network at least comprises Bluetooth or Wi-Fi.

6. The method as defined in claim 1, wherein the smart terminal receives the audio input signal through an audio transducer or a built-in audio module.

7. A smart terminal for controlling web application a processor and a non-transitory storage medium accessible to the processor, the non-transitory storage medium is configured to store:
an initiation module configured to notify the server device to enter an audio control mode, after the smart terminal authenticates and registers with the server device;
a detection module configured to receive an audio input signal and detect a signal level of the audio input signal; and
a control module configured to notify the server device to trigger control of corresponding web application, based on the detected signal level.

8. The smart terminal of claim 7, wherein the control module is configured to notify the server device to trigger control of the web application when the signal level of the audio input signal is higher than the preset dB threshold corresponding to the web application.

9. The smart terminal of claim 8, wherein the control module is configured to notify the server device to control the web application to a corresponding response based on the detected change in dB level of the audio input signal.

10. The smart terminal of claim 7, wherein the initiation module is configured to search for the server device through a wireless network and, after finding the server device, initiating an authentication and registration process.
